(19) United States
(12) Patent Application Publication
(10) Pub. No.: US 2026/0206999 A1
(43) Pub. Date: Jul. 23, 2026

(54) DEVICE FOR THE PRODUCTION OF MILK FROTH

(71) Applicant: Xtraction AG, Schenkon (CH)

(72) Inventor: Christoph KAUFMANN, Schenkon (CH)

(73) Assignee: Xtraction AG, Schenkon (CH)

(21) Appl. No.: 19/136,444

(22) PCT Filed: Dec. 5, 2023
(86) PCT No.: PCT/EP2023/084287

§ 371 Date: Jun. 6, 2025

(30) Foreign Application Priority Data
Dec. 8, 2022 (EP) 22212154.3

(51) Int. Cl. A47J 31/44

(52) U.S. Cl. CPC A47J 31/4485

(57) ABSTRACT

Device for the production of milk froth, wherein the device includes at least one pump for the suction of milk from at least one milk container, and downstream thereof a homogeniser, wherein the pump is an impeller pump with an impeller toothed wheel at least three elastic vanes. Downstream of the impeller pump and upstream of the homogeniser there is a mixing element for introducing at least one of air and steam. The homogeniser comprises at least two counter rotating toothed wheels mounted such that the teeth thereof are intertwining. One of the toothed wheels and the impeller toothed wheel of the impeller pump are driven by the same motor.

### TECHNICAL FIELD

The present invention relates to a device for the production of milk froth as well as to methods for operating such devices.

### PRIOR ART

DE-A-10 2015 120 238 relates to a milk-frothing device with a mechanical emulsification device, comprising a stator and a rotor which can be driven rotatably about an axis of rotation relative to the stator. Milk and air can be fed to the emulsification device on the inlet side and shear forces can be released by rotation of the rotor relative to the stator by means of a drive, and milk froth can thereby be produced. The milk froth can be discharged on the outlet side. In order to produce the shear forces, both the rotor and the stator have a plurality of shear element rows comprising shear elements. The shear element rows of the rotor and the shear element rows of the stator interdigitate intermittently in such a way that the milk and air flowing through the intermittent shear element rows can each be sheared between one of the shear element rows of the rotor and a directly adjacent shear element row of the stator upon rotation of the rotor.

EPA-2 294 296 discloses the use of a high shear mechanical device in a process to produce aerated fuels for efficient combustion in an engine. In instances, the method comprises forming an emulsion of a gas and liquid fuel in a high shear device prior to introduction to an engine. A vehicular system for producing aerated fuels comprising a high shear device.

EP-A-2 934 251 provides a device for producing milk foam, which makes use of Couette flow and a high shear stress that is accordingly applied to a milk-air mixture in a gap between a housing, in particular an outer cylinder, and a rotating element rotating arranged therein. The device further comprises a milk supply circuit supplying the fluid inlet with milk and an air supply circuit supplying the fluid inlet with air, both supply circuits being independent from each other.

EP-A-3 076 839 relates to a milk-frothing device with a dynamic mixing unit having a stator and a rotor which can be set in rotation relative to the stator, rotor and stator being configured such that milk and air can be conducted firstly to the dynamic mixing unit, subsequently, for frothing-up in the dynamic mixing unit, can be subjected multiple times to a shearing effect by rotation of the rotor relative to the stator and finally can be discharged out of the dynamic mixing unit.

EP-A-3 262 995 relates to a coffee machine comprising a milk frothing device, wherein the milk froth of a further beverage component, specifically, coffee can be added. The coffee machine comprises an injection unit for leaching out and/or dissolving beverage substrate provided in beverage substrate capsules, or an integral mill and a brewing unit. Ground coffee produced by the integral grinder of coffee beans is leached, and the milk frothing device has a mechanical emulsification device which comprises a stator and a rotor which can be driven rotatably about an axis of rotation relative to the stator, wherein milk and air can be fed to the emulsification device on the inlet side and shear forces can be released by rotation of the rotor relative to the stator and milk froth can thereby be produced. The milk froth can be discharged on the outlet side. Both the rotor and the stator comprise a plurality of rows of shearing elements comprising shearing elements. The shearing element rows of the rotor and the shearing element rows of the stator are engaging one another intermittently in such a way that in the case of rotation of the rotor, milk and air flowing during rotation of the rotor can in each case be sheared between one of the shear element rows of the rotor and an immediately adjacent shear element row of the stator.

EP-A-3422912 relates to a milk-frothing system which includes a gear pump which, at an inlet side is connected at least to a milk feed conduit that, for its part, is connected during operation to a milk vessel that can be filled with milk, for example by way of it projecting into the vessel. The gear pump sucks milk out of the milk vessel via the milk feed conduit. The system also includes a feed conduit for water and/or steam to the gear pump, for example in order to rinse this after use or also, by way of the feed of steam, to heat the delivered milk. The milk-frothing system is configured, under predefined conditions and before delivery of milk, to deliver water and/or steam to the gear pump via the feed conduit, in order to wet the gear pump.

EP-A-3 672 456 relates to an inline fluid foaming device for providing a foamed fluid directly into a container, the device comprising an air path for introducing a certain quantity of air into the device, and a fluid path for introducing fluid into the device coming from a fluid container, the mixture of air and fluid passing to a centrifugal pumping and foaming element such that the amount of fluid into the device is pumped by the centrifugal movement of the pumping and foaming element and the foaming of the mixture is provided by driving it under a certain level of shear stress in the element, the device further comprising a heating unit to where the foamed mixture of fluid and air is conveyed for its optional later heating. The invention further relates to a beverage system comprising such an inline fluid foaming device and a beverage-dispensing machine.

US-A-2017156544 discloses a beverage supply device applied to a beverage dispenser providing a beverage to a beverage container and has a beverage supply route for supplying a milk beverage to the beverage container, includes a washing unit to, in response to a washing instruction, mix an undiluted wash fluid with a wash hot water to generate a wash fluid, the undiluted wash fluid being supplied from an undiluted wash fluid accommodating unit configured to accommodate the undiluted wash fluid, the hot water being supplied from a hot water storage unit configured to stores the hot water which is for generating pressurized steam for forming the milk beverage, supply the wash fluid to the beverage supply route communicating with the washing unit, and supply the hot water supplied from the hot-water storage unit to the beverage supply route as a rinse hot water.

US-A-2017156544 relates to a beverage supply device applied to a beverage dispenser providing a beverage to a beverage container and has a beverage supply route for supplying a milk beverage to the beverage container, includes a washing unit to, in response to a washing instruction, mix an undiluted wash fluid with a wash hot water to generate a wash fluid, the undiluted wash fluid being supplied from an undiluted wash fluid accommodating unit configured to accommodate the undiluted wash fluid, the hot water being supplied from a hot water storage unit configured to stores the hot water which is for generating pressurized steam for forming the milk beverage, supply the wash fluid to the beverage supply route communicating with the washing unit, and supply the hot water supplied from the hot-water storage unit to the beverage supply route as a rinse hot water.

WO-A-2016142318 relates to a milk-frothing device having a mixing chamber which is constructed in such a way that, when milk flows through the mixing chamber, shearing forces act on the milk and result in the mechanical lysis of the proteins contained in the milk, thus resulting in an improved frothing of the milk. The invention also relates to a beverage maker comprising said milk frothing device, and to a method for frothing milk using said milk frothing device.

WO-A-2017081308 relates to a pumping and foaming device comprising a pumping and foaming unit rotatable around a shaft by driving means, the pumping and foaming unit comprising a pumping element whose rotation pumps both air and fluid and mixes them; the pumping and foaming unit further comprising a foaming element whose relative rotation in a foaming chamber drives the mixture of air and fluid coming from the pumping element under a certain level of shear stress which allows this mixture to be foamed.

From different fields certain types of pumps are known as follows:

US-A-2008203591 relates to a flexible impeller pump includes first and second component housings. The first component housing includes a first flexible impeller and the second component housing includes a second flexible impeller. As these impellers rotate within their respective housings, they draw in and expel individual components into a common receiving chamber. In a particular application, one component is a foamable liquid, and the other component is air, and a mixture of foamable liquid and air is thus created in the common receiving chamber.

US-A-2010000502 relates to the use of a high shear mechanical device in a process to produce aerated fuels for efficient combustion in an engine. In instances, the method comprises forming an emulsion of a gas and liquid fuel in a high shear device prior to introduction to an engine. A vehicular system for producing aerated fuels comprising a high shear device.

US-A-2018010612 provides a disposable fluid pump with a housing including first and second faces, with a sidewall extending between the first and second faces. The housing defines a chamber, with an inlet and an outlet in fluid communication with the chamber. An impeller is rotatably mounted within the chamber and includes a plurality of flexible vanes. Such a pump may be incorporated into a disposable fluid flow circuit that is adapted to be mounted on a durable hardware for processing a fluid. In such a fluid flow circuit, the fluid pump may be integrated into a cassette of the circuit or, alternatively, the inlet and outlet of the fluid pump may be directly connected to fluid flow conduits of the circuit.

DE-U-20 2006 010 360 discloses an impeller pump in the context of galvanic applications for transport of liquids and air mixtures comprises an integral dry-running probe for determination of the amount of air in such mixtures. An independent claim is also included for a suction system with the proposed impeller pump.

US-A-2011143006 discloses a device for producing froth which comprises means which are adapted to perform a pumping function and to perform a mixing process of at least one liquid and a gas at the same time. Furthermore, the device comprises suitable means for supplying the liquid and the gas to the pumping means, and suitable means for discharging froth from the pumping means. In order for the device to be capable of producing hot froth, means for supplying steam are provided, and arranged such as to supply the steam directly to the pumping means, in particular to an outlet side of the pumping means. This way of attributing a heating functionality to the pumping means has many advantages, including the option of a most compact design. Furthermore, the steam may be used for cleaning the pumping means.

### SUMMARY OF THE INVENTION

It is therefore an object of the present invention to provide an improved device for the production of milk froth. The device is to provide for stable and continuous high output milk froth, and it is to be easily cleanable and reliable.

According to a first aspect of the present invention, therefore a device for the production of milk froth is proposed, wherein the device comprises at least one pump for the suction of milk from at least one milk container, and downstream thereof a homogenizer.

According to the present invention, the pump is an impeller pump with an impeller toothed wheel with at least three elastic vanes. Furthermore downstream of the impeller pump and upstream of the homogenizer there is provided a mixing element, typically a mixing chamber, for introducing at least one of air and steam. According to the invention, furthermore the homogenizer comprises at least two counter-rotating toothed wheels mounted such that the teeth thereof are intertwining, wherein preferably one of said toothed wheels and the impeller toothed wheel of the impeller pump are driven by the same motor. This specific combination provides for a milk froth production device, which makes available the above properties, which in addition to that can be produced efficiently and which allows for long-time stable operation.

According to a first preferred embodiment of such a device, the impeller toothed wheel and one of said toothed wheels are mounted on the same shaft or collinear coupled shafts, preferably mounted collinear with an engine shaft of said motor.

Typically, the impeller toothed wheel comprises not more than in the range of 4-10 elastic vanes, preferably not more than in the range of 5-8 elastic vanes.

Preferably, each of the elastic vanes of the impeller toothed wheel has a widened tip portion to contact the walls of a cavity of the impeller toothed wheel.

The cavity for such an impeller toothed wheel has an asymmetric shape in the sense that it comprises a circumferential section which is essentially circular cylindrical (having an inner diameter essentially corresponding or only slightly smaller than the radius of the elastic vanes of the impeller toothed wheel in essentially unbent state), and at least one circumferential section which is flattened, which means that the diameter with respect to the axis of the wheel is smaller than in the essentially circular cylindrical section (the smallest radius of that circumferential section having an inner diameter smaller than the radius of the elastic vanes of the impeller toothed wheel in essentially unbent state, so that the elastic vanes of the impeller toothed wheel are significantly bent in that section).

So more specifically, according to a preferred embodiment the impeller pump comprises a cavity in which the impeller toothed wheel is mounted, and where the inner wall of the cavity comprises a circular cylindrical section and opposite thereof a flattened section.

Typically, at the position with the smallest radius the radius in that flattened section is at least 20%, preferably at least 30%, or at least 40% or 50% smaller than the radius of the circular cylindrical section.

According to yet another preferred embodiment, the impeller pump and the homogenizer are located in one common housing, preferably having an impeller pump section and homogenizer section attached to each other or being one-part.

Another preferred embodiment is characterized in that the impeller toothed wheel is mounted on a shaft which at the same time acts as at least partial shaft of one of said toothed wheels, wherein this shaft or in case of this shaft being a partial shaft of one of said toothed wheels a further shaft of said toothed wheel is directly and collinearly connected with the engine shaft of the motor.

The homogenizer preferably comprises only two counter rotating toothed wheels and said two counter rotating toothed wheels of the homogenizer are mounted in a housing. The housing preferably forms a cavity with a first cavity portion with essentially cylindrical shape and a second adjacent cavity portion with essentially cylindrical shape. Said portions are connected in a restricted portion of the cavity, in which restricted portion the teeth of the counter rotating toothed wheels are intertwining.

The impeller pump further preferably comprises a cavity, in which the impeller toothed wheel is mounted, and wherein the inner wall of the cavity comprises a circular cylindrical section and opposite thereof a flattened section, wherein the milk inlet is located in a first transition portion between the circular cylindrical section and the flattened section and wherein the milk outlet is located in a second opposite transition portion between the circular cylindrical section and the flattened section.

The mixing element is preferably located at the end of the milk outlet.

Further preferably, the mixing element takes the form of a circular cylindrical mixing cavity (preferably it is just a cavity without any additional active or passive mixing elements located therein).

The mixing element typically comprises an air inlet, the direction of introduction is essentially orthogonal to the direction of introduction of milk through the milk outlet.

Preferably, this air introduction direction is parallel to the axis of the circular cylindrical mixing cavity of the mixing element, and further preferably the mixture exits the mixing element to enter a cavity of a toothed wheel of the homogenizer which is not directly driven by the motor. It is preferred and particularly advantageous if the air is introduced downstream after the impeller pump

Preferably, the mixture exits the mixing element in a direction essentially parallel to the air introduction direction.

Further preferably, the device further comprises heating means for heating the milk, wherein the heating means can be provided downstream of the homogenizer and/or can be part of or integrated with the homogenizer.

At the outlet from the homogenizer there is preferably no flow cross-section constriction and/or valve to generate counter pressure.

Downstream of the homogenizer and/or of a heater downstream of the homogenizer, there can be provided a static mixer in the flow path. Also, such a static mixer can be provided upstream of the homogenizer or even upstream of the impeller pump.

Such a static mixer is preferably of a non-helical or non-spiral type, but rather of a labyrinth type with a series of alternatingly located wall sections extending in a direction perpendicular to the flow direction. Preferably these alternatingly located wall sections are provided with further wall sections, so forming an L-shape, wherein further preferably the sections located parallel to the flow point with their free end counter to the flow direction of the milk. Preferably the wall sections are located between two longitudinal walls defining an insert of the mixer which, located in a tube, provides for the actual static mixer. An example of such a static mixer is given in the example section, the specifics of this mixer are not restricted to the dimensions and proportions as illustrated in the figure and can be generally used in the context of this device.

Further preferably, the impeller toothed wheel may comprise a rigid mounting (ring) portion mounted on a shaft, and it may comprise a circumferential elastic portion integrally forming also the elastic vanes and, if present, widened tip portions thereof.

Preferably, only one first toothed wheel of the homogenizer is directly driven by the motor, while the other second toothed wheel of the homogenizer is driven only by said first toothed wheel, preferably due to the intertwining of the respective teeth.

In addition to the device, the present invention also relates to a method for operating such a device.

Typically, in such a method, the impeller pump sucks milk, preferably cold milk, from at least one milk container (e.g. located in a fridge) and propels the milk into the mixing element, and an air pump sucks air and/or steam and propels it in parallel into the mixing element, the mixture is fed into the homogenizer, preferably in a cavity portion of a first homogenizer toothed wheel, and milk froth exits the homogenizer from a cavity portion of a second homogenizer toothed wheel which is driven by the same motor as the toothed wheel of the impeller pump.

It is preferred and advantageous if the air supply takes place after, i.e. downstream of the impeller pump, as claimed in presently worded claim 1. As a result, the impeller pump as a positive displacement pump can overcome and handle high suction heights and suck-in reproducibly well-defined milk quantities. If the air is sucked upstream of the pump as in most milk system applications, there is a risk of a stall point if the air intake is too high.

At the outlet from the homogenizer there is preferably no flow cross-section constriction and/or valve to generate counter pressure.

Preferably, in the homogenizer there is a pressure of at most 2 bar and/or a flow in the range of 5-20 ml/s, preferably in the range of 7-15 ml/s.

After production of milk froth or before production of milk froth the device is typically provided/rinsed, instead of milk, with a cleaning liquid, in the form of water or a cleaning liquid if need be mixed with water, and operated/circulated with that cleaning liquid for a time span of at least 1 minute or at least 5 minutes, preferably at least 15 minutes, and subsequently the device is operated under conditions where it is provided with clean water until the device is free from cleaning liquid.

Also the present invention relates to a cold or hot beverage preparation machine, in particular a coffee machine, comprising a device as detailed above or being attached or coupled with such a device (in the sense of a cold or hot beverage preparation machine comprising a device as detailed above in that it is attached or coupled with it), and/or being suitable and adapted to carry out the method as detailed above.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a side view of a device for the production of milk froth;

FIG. 2 shows a central axial cut through a device for the production of milk froth;

FIG. 3 shows a cut along the dashed line in FIG. 2;

FIG. 4 shows a cut along the dotted line in FIG. 2;

FIG. 5 shows an explosion view of the device for the production of milk froth;

FIG. 6 shows a schematic flow diagram of a device for the production of milk froth in foam dispensing mode;

FIG. 7 shows a schematic flow diagram of a device for the production of milk froth in cleaning mode;

FIG. 8 shows a schematic flow diagram of a device for the production of milk froth in cleaning mode with a heating element integrated into extractor system

FIG. 9 shows a static mixer, wherein in a) a perspective view onto the mixer insert is shown, in b) a side view perpendicular to the lateral side wall and in c) a side view parallel to the lateral sidewalls allowing a view into the interspace between the two lateral longitudinal sidewalls.

### DESCRIPTION OF PREFERRED EMBODIMENTS

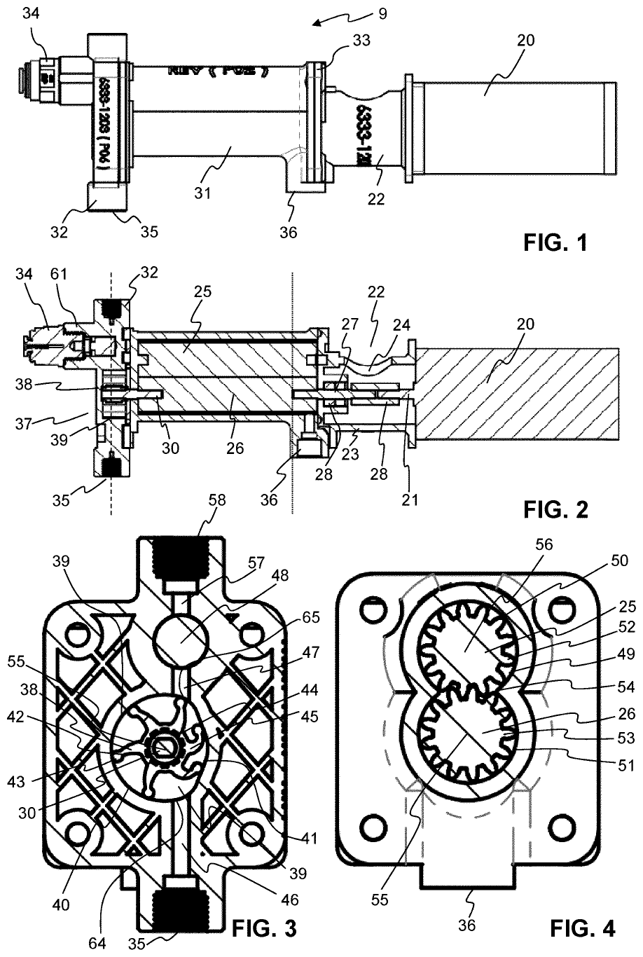

FIG. 1-5 show different representations of a homogenizer or more generally speaking a device for the production of milk froth or of one central element thereof.

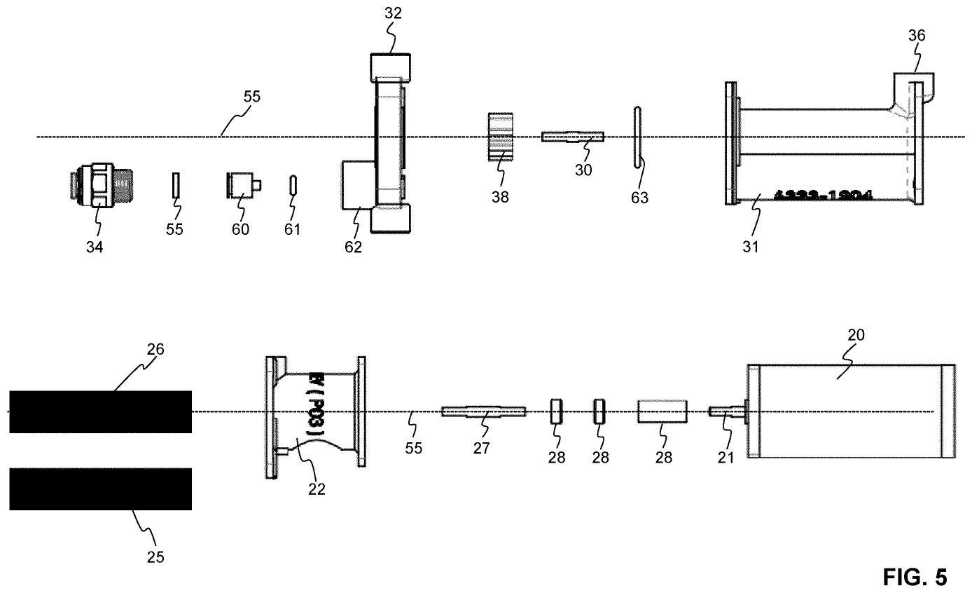

Specifically, FIG. 1 shows a side view, FIG. 2 shows a central cut through such a device along the motor axis direction, FIG. 3 shows a cut along the dashed line in FIG. 2, FIG. 4 shows a cut along the dotted line in FIG. 2, and FIG. 5 shows an explosion view of the device for the production of milk froth.

The same reference numerals are used for indicating the same elements in the various figures.

With specific reference to the representation in FIG. 1, the device comprises the actual homogenizer 9, which is driven by a motor 20. The motor 20 section is connected to a housing 31, in which a pair of toothed wheels, an upper homogenizer toothed wheel 25, also designated as second extractor, and a lower homogenizer toothed wheel 26, also designated as first extractor, are mounted in parallel axis arrangement.

The motor 20 is connected to that housing 31 by way of a coupling unit 22, which on its upper side has an opening 24 for allowing access to the elements contained in that coupling unit 22. The connection of that coupling unit 22 to the housing 31 is provided by way of an attachment flange 33 provided on the coupling unit 22.

On the other side of the housing 31 there is provided a housing 32 of an impeller pump section. That housing 32 may be a separate part from the homogenizer housing 31, or the two housings 31 and 32 may be formed from one piece.

The impeller pump section housing 32 on its lower part is provided with a milk inlet 35, which is typically connected to a milk container 5 or at least to tubing, which allows to connect a milk container (see also description further below).

Also, the impeller pump section housing 32 in its upper part is provided with an air inlet 34, which is typically connected to a pressurized air system 19 or at least to tubing which allows to connect to a pressurized air system or to an air pump (see also description further below. Milk sucked in by way of milk inlet 35 is mixed with air introduced by way of air inlet 34, mixed in a first stage within the housing of the impeller pump section 32 but downstream of the actual impeller pump 37 in a mixing element and subsequently further mixed to form milk froth in the section 31, and milk froth exits that housing by way of the foam outlet 36 provided on the bottom part of the homogenizer housing 31.

With specific reference to the representation in FIG. 2, the motor 20 is provided with an engine shaft 21 pointing in the direction of the homogenizer housing 31 and penetrating into the interior of the coupling unit 22, so into the space bordered by sidewall 23 of the coupling unit 22.

Within that coupling unit 22, the motor shaft 21 is firmly connected with a further shaft 27 by way of a coupling sleeve 28. That further shaft 27 is mounted in at least one bearing 28 in the coupling unit 22 or in the housing 31, and on the side opposite to the motor 20 is carrying or forming part of the above-mentioned lower homogenizer toothed wheel 28.

Like that, the engine shaft 21 of the motor 20 is arranged collinearly with the shaft 27 and correspondingly with the axis of the lower homogenizer toothed wheel 26.

Also arranged collinearly with that axis 55 (see FIG. 4) is the shaft 30 which carries and mounts the lower homogenizer toothed wheel 26 on its other end and is mounted in a corresponding bearing in the housing 32 or in a corresponding part of the housing 31. This shaft 30 penetrates further into the housing 32 of the impeller pump section, and also acts as the shaft for the toothed wheel 38 of the impeller pump 37.

This means that the engine shaft 21 and the shaft 30 of the impeller pump wheel 38 are collinearly and rigidly connected, such that the motor 20 drives not only the lower homogenizer toothed wheel 26 but also and concurrently the wheel 38 of the impeller pump. With reference to the representation in FIG. 3, milk introduced by way of milk inlet 35 is transported upwards in the direction of the impeller pump 37. The impeller pump 37 is centrally mounted on the axis 55 on the shaft 30 and the actual toothed wheel 38 has a rigid ring-shaped mounting portion 44 for mounting it on the shaft 30, which is surrounded by an elastic portion 45. This elastic portion 45 comprises, in this case, six elastic vanes 42, which act as flexible teeth of the impeller pump. On their tips, these vanes 42 are provided with widened tip portions 43 for assuring defined contact with the wall in unbent but also in bent state.

This impeller toothed wheel 38 is mounted in a cavity 39 in the housing 32. This cavity 39 has a special shape, namely on one (in the figure left) side it has a circular cylindrical sidewall 40, and on the opposite (n the figure right) side it has a flattened sidewall portion 41 with lower diameter than the radius of the unbent vanes of the toothed wheel of the impeller wheel.

This interior shape of the cavity 39 has the effect as illustrated in FIG. 3, namely that upon rotation of the impeller pump toothed wheel 38 in a clockwise direction, on the right side the elastic vanes 42 are bent backwards while on the left side where the cavity has a circular cylindrical sidewall 40 they are essentially in an extended state, which means that the interspace between adjacent vanes 42 or the volume between adjacent vanes 42 is large in the left hemisphere, while it is small in the right hemisphere of that cavity.

This in turn means that milk, which enters the unit by way of opening 35 on the bottom via channel 46 is sucked into the cavity 39, so it travels through the milk inlet tube 46 and enters the cavity 39 at the lower transition portion 64 at the corresponding inlet opening to the cavity 39, and exits the cavity 39 at the upper transition portion 65 by way of the milk outlet 47.

The milk outlet tube 47 ends in a mixing element in the form of a pre-mixing chamber 48 which in this case has a circular shape in the viewing direction in FIG. 3. Also, air introduced by way of the air inlet 34 enters into that premixing chamber 48, and correspondingly in that premixing chamber 48 a first mixing of pressurized air and/or steam and milk takes place. If pressurized steam is to be introduced separately and not via 34, this can be done by way of the optional inlet 58 and the corresponding pipe 57 from a top direction.

The mixture produced in that premixing chamber 48 is then channeled through an opening in the partitioning wall between the housing 31 and the housing 32 and enters into an upper portion of the housing 31, specifically, as illustrated in FIG. 4, into the upper cavity portion 50 in which the upper homogenizer toothed wheel 25 is mounted with its axis 56 parallel to the axis 55 of the main extractor 26.

The upper extractor 25, like the main extractor 26, are each provided with a series of parallel teeth 52/53, and the two toothed extractor wheels 25 and 26 are mounted such that these teeth 52/53 intertwine in an overlapping housing portion 54. This overlapping portion is located in the restricted portion 54 of the cavity 49 for the homogenizer toothed wheels. In fact, this cavity 49 has an upper portion 50, in which the upper homogenizer 25 is located and the inner circumference of which essentially corresponds to the outer diameter of the toothed wheel 25. Adjacent to that and below is located a lower cavity portion 51, in which the main extractor 26 is located again, with axis parallel to the axis of the upper extractor, having an outer diameter essentially corresponding to the inner diameter of the lower cavity portion 51. In the restricted portion 54, these two sections of the cavity 49 are interconnected and this is where the teeth of the two toothed wheels 25/26 intertwine. The upper toothed wheel 25 is not actively driven by the motor, but only indirectly by this intertwining of the teeth 52 with the teeth 53 of the main extractor 26.

This means, that the air/steam mixture with milk that is formed in the premixing chamber 48 is entering the upper cavity portion 50 in the homogenizer housing 31, and is then transported and further homogenized and mixed at the same time by the two extractor wheels 25 and 26 upon formation of a solid and stable milk froth to exit by way of the foam outlet 36.

At the outlet from the homogenizer there is no flow cross-section constriction and/or valve to generate counter pressure.

As a preferred embodiment, the device as illustrated in FIGS. 1-5 can be provided with a heating integrated into for example the housing 31. In this case, the input can be cold milk and the output will be hot milk froth.

In an alternative, it is possible to have milk heating means downstream of the corresponding device, so downstream of the outlet 35.

Experimental evidence shows that the corresponding milk froth is particularly stable, and can be produced using cold milk input for making cold milk froth, but it can also be produced using warm/hot milk input for making warm/hot milk froth.

It could be shown that the corresponding milk froth is more stable and more reliable compared with using systems with conventional pumps instead of impeller pumps and compared with the systems which do not have a premixing chamber upstream of a homogenizer with two toothed wheels. So the stability and the reliability of the milk froth is due to the specific combination of having an impeller pump, downstream thereof a premixing chamber for mixing hot air or steam or cold air with the milk, and to then provide downstream thereof a homogenizer with at least two toothed wheels.

Furthermore, stable operation and easy cleaning conditions are made available by providing the motor collinear with one of the homogenizer toothed wheels and collinear with the wheel of the impeller pump to drive at the same time the homogenizer as well as the impeller pump. Also this provides for easy control and optimum stability of the device.

Such a device can be stand alone or it can be integrated into a coffee machine, but it can also be integrated into a milk dispensing device, or into a combination thereof. As will be detailed further below, the proposed device can be cleaned or can be made to clean itself very efficiently at the end of the shift or even between shifts.

The corresponding device as illustrated in FIGS. 1-5, but also as generally described in the above general description, can be provided with appropriate sensing means for control.

Specifically, a conductivity and/or temperature sensor can be provided in the inlet portion for the milk, typically upstream of the impeller pump.

In addition to that or in the alternative, a temperature sensor can be provided at the outlet 36 or downstream thereof e.g. to measure the temperature of the milk froth.

Also, pressure and/or temperature sensors can be provided at the air/steam inlets. Also corresponding flowmeter sensors can be provided in these portions of the device.

The device can be operated with dairy milk, plant based milk (for example oat, coconut, almond, soy, pea or others) or a combination thereof. Also flavoured milk can be used, fresh milk or long life milk and cold brew liquid coffee.

The proposed device allows a capacity in the range of 600 mL/min for hot and cold milk, and for hot and cold liquid foam the capacity can be in the range of 700 mL/min and for hot and cold solid foam the capacity can be in the range of 800 mL/min.

Hot milk foam can be provided in the temperature range of 68-75° C. (measured at the outlet head), and hot milk can be provided in a temperature range of 75-80° C. (again measured at the outlet head).

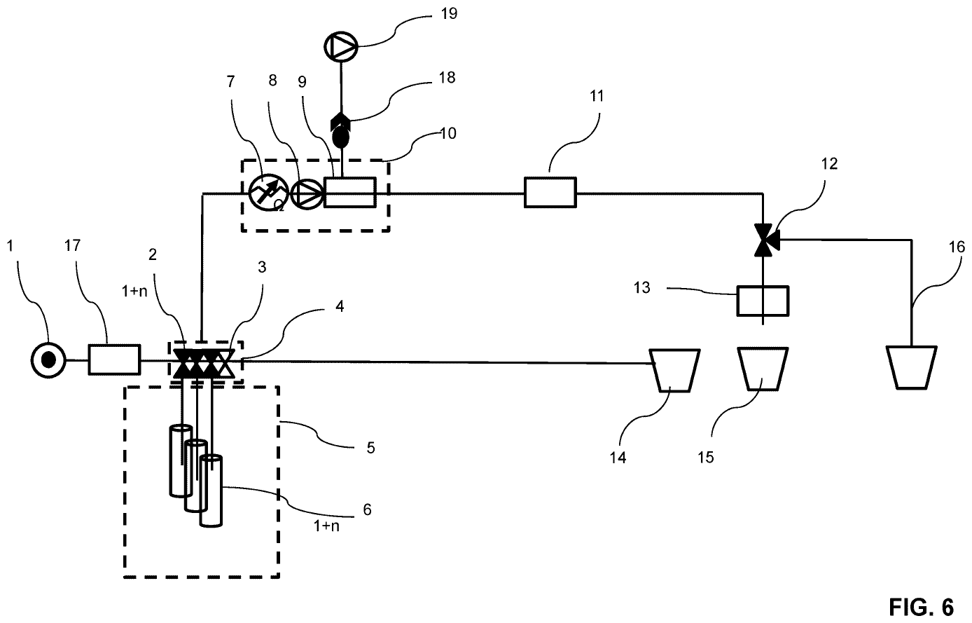

FIG. 6 shows a flow diagram how such a device can be operated for the production of milk froth in foam dispensing mode. Milk can be provided to the milk inlet 35 from a cooling unit or fridge 5, in which several milk containers 6 (for example containing different types of milk) are provided. To control the corresponding milk source, a manifold valve block 4 can be provided on top of the fridge, and a clean manifold block can be attached to that manifold 4 controlled by a flowmeter 17 and if needed, supplied by a separate water pump if the water supply is not under sufficient pressure. In that manifold 4 there is an inlet valve 2, as well as a clean return valve 3, to control the cleaning process as will be detailed further below.

Milk is then channeled to the actual extractor system 10, which comprises the device illustrated in FIGS. 1-5. In that schematic diagram, there is provided a conductivity sensor upstream of the device, and the impeller pump is illustrated by reference numeral 8 schematically, and so is the homogenizer 9. An air pump 19 provides for pressurized air which is entering the system by way of a check valve 18.

The milk froth exiting the homogenizing device in this case is heated downstream of that device in corresponding heating elements, which can be a thick film heating system 11. Downstream thereof there is a valve 12 for cleaning purposes, and downstream of that valve there is an outlet head 13 for supply to drink cup 15. In the cleaning process, the valve 12 can be used to redirect the output by way of wastewater line 16 to a corresponding waste container. Also for cleaning, a cleaning liquid container 14 is provided which is also connected to the manifold 4.

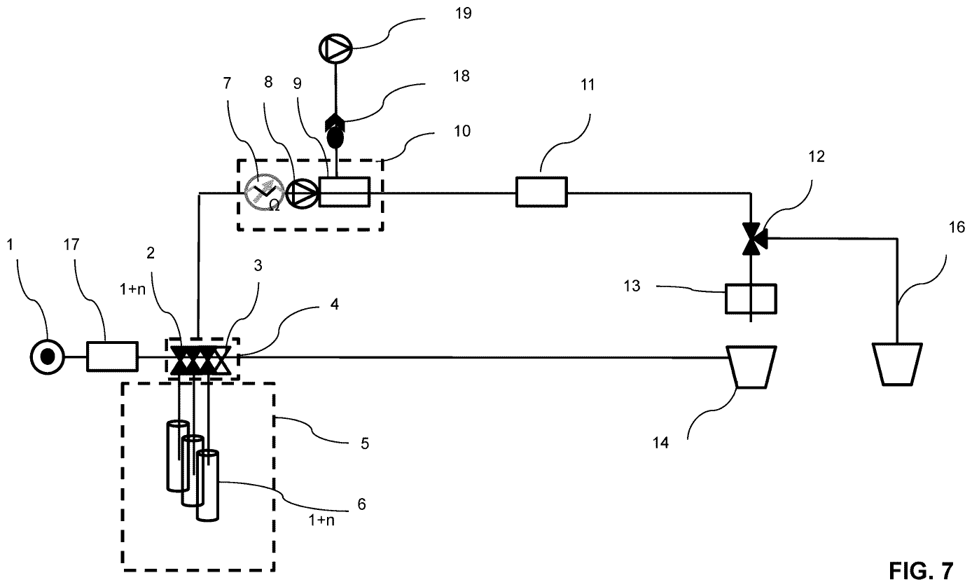

FIG. 7 shows a schematic flow diagram of such a device in cleaning mode. In this case, the liquid from the container 14 is channeled by way of the manifold 4 to pass through the extractor 10, in corresponding suitable and adapted combination with water supplied from source 1. Water exiting the extractor 10 is then channeled by way of valve 12 to the wastewater drain channel 16 and to a corresponding drainage container.

The cleaning process can be fully automated without a manual interaction. Especially for vending applications can be a big advantage. The cleaning can be done also easily during the day when there is a downtime. The cleaning especially with fresh milk and bigger drinks and milk volumes >40 liters (long run time with max temperature) tend to contaminate the tubes and heater and there is a risk of blockage.

Several cleaning processes can be applied during the day with activating the cleaning process as following:

Flash after each drink: (Process steps: to avoid any milk residues outside the fridge during rest period of the machine the flash already starts before the end of a drink cycle. The flash water rinses the entire milk channels and is flashed out via the 3/2 valve into the drain. A special control procedure with different components (ON/OFF) is required to avoid any air bubbles at the end of the drink supply.

Flash in between two types of drink: This is a settable procedure especially when dairy and none-dairy products are applied. Based on tests there is more contamination when switch from non-dairy to a dairy product (as versa) longer rinse time is a settable parameter as well.

Cleaning procedure during the day settable by volume of used milk or at the end of a shift. A pre-warning of the cleaning process will be come up for internal cleaning and flash out in front into the drip tray. A cleaning process has to be done otherwise the system will be blocked. For high volume stores a multiple cleaning procedure can be most efficient. Normally these outlets have 3 rush hours times. In between there is enough time to clean and the cleaning process time of multiple cleaning can be reduced.

Process steps: (all time parameters settable)
Flash with cold or hot water approx. 8 s;
Fill hot water (Temperature hot water 65-75° C.) up system with Cleaner from micro dosing pump (Volume in total system-Diameter inner 4 mm, length approx. 2 m-=25 ml) approx. 3-4 s via direct outlet and via drain;
Soak time 1 min;
Flash with hot or cold water out via outlet head and via drain (3 s each total 6 s);
Repeat step previous steps 3 times;
Post rinse: Flash with hot or cold water out via outlet head (15 s) and via drain (5 s).

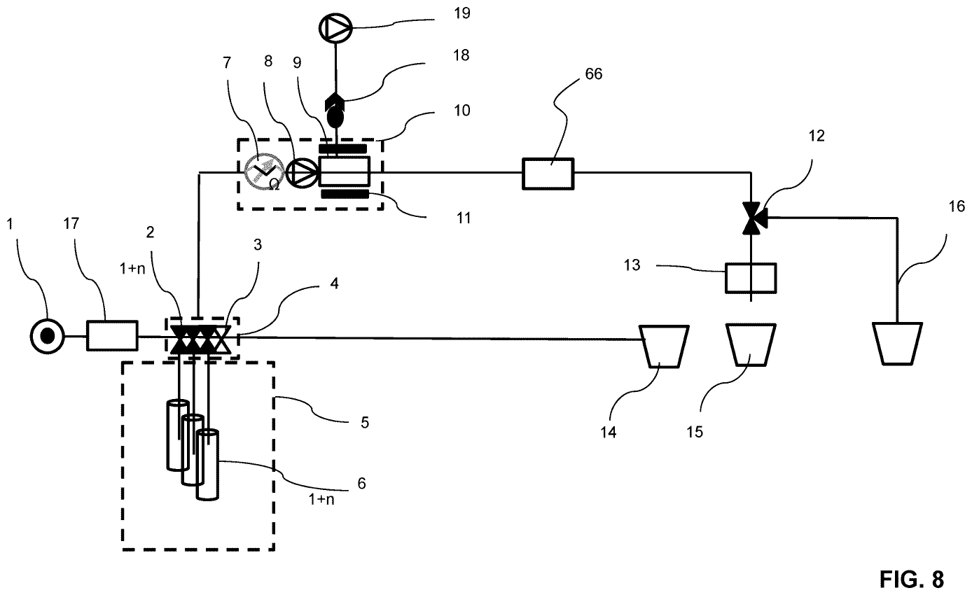

FIG. 8 shows a schematic flow diagram for a system in which the heating is integrated into the extractor. In this case, a thick film heating system is integrated into the housing 31 of the extractor as illustrated above in more detail in the context of FIGS. 1-5.

FIG. 8 shows a schematic flow diagram for a system in which the heating 11 is integrated into the extractor 9 and as an option in this case downstream of the extractor 9 there can be provided a static mixing element 66.

Such a static mixing element can also be used in the context of systems where the heating 11 is not integrated in the extractor 9, i.e. in systems as illustrated in FIG. 7, and in this case the static mixing element 66 can be located upstream or downstream of the heating element 11 or even upstream of the homogenizer, preferably it is located downstream of the heating element 11.

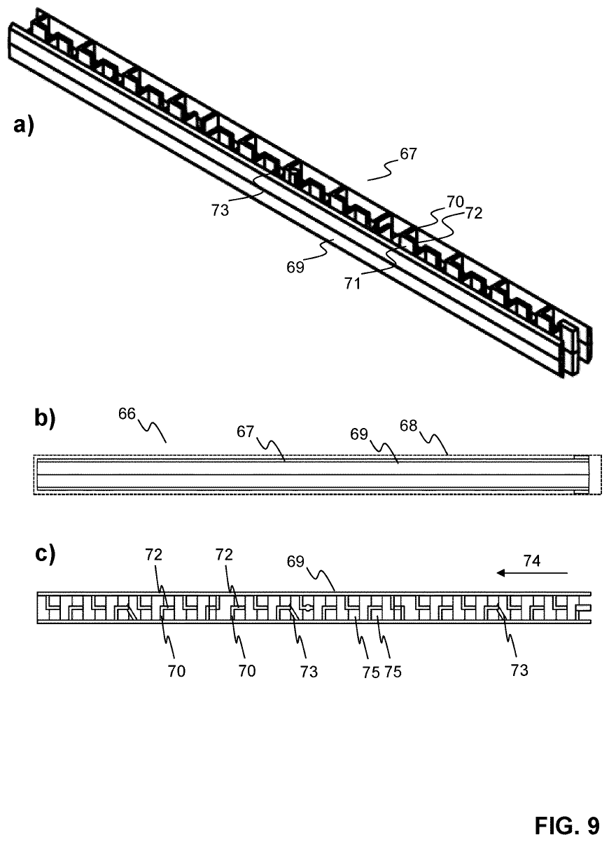

A possible implementation of such a static mixing 66 element is illustrated in FIG. 9. Preferably such a static mixing element 66, to lead to a particularly stable milk foam independent of the temperature of the milk, can be provided in the form of a mixer which, in a tube (schematically illustrated with dashed lines in FIG. 9b) comprises a mixer structure, which is not of the spiral or helix type, but which comprises a particular insert 67 which is located in a tube 68. The insert 67 comprises a pair of lateral longitudinal sidewalls 69 which extend within the circular outer tube 68 in a way such that in the long edges of the longitudinal sidewalls 69 about and seal with the inner wall of the tube 68 so that in the outer interspace between the longitudinal sidewalls 68 and that portion of the tube there is no flow of milk. The milk only flows in the inner interspace between the two lateral sidewalls 69.

Between these two lateral sidewalls 69 there is a series of wall sections which penetrate into that interspace. The wall sections are L-shaped, each with a transverse wall section 70 and a perpendicularly oriented connected longitudinal wall section 72. The transverse wall section 70 extends about half the distance between the two longitudinal sidewalls 69, so that between the transverse wall section 70 and the opposing longitudinal sidewall there is a flow-through path 71. These L-shaped wall sections 70/72 penetrate into the interspace between the two longitudinal sidewalls in an alternating manner from both sides, providing a labyrinth for the milk flowing through that interspace in a direction along arrow 74, i.e. in a direction opposite to the free end of the longitudinal wall sections 72.

In certain places, typically after about four or more alternating L-shaped wall sections 70/72 there can be provided converging wall sections 73 connecting the free end of the longitudinal wall section 72 with the longitudinal sidewall 69 to provide for funnel like portions in the static mixer.

Between the two lateral longitudinal sidewalls 69 there are provided spacer wall sections 75 extending over the full distance between the two longitudinal sidewalls 69 and oriented perpendicular to both the transverse wall sections 70 and the longitudinal wall sections 72.

Providing such a static mixer either downstream of the homogenizer comprising a heating element, downstream of the homogenizer and upstream of the heating element, or downstream of the homogenizer and downstream of the heating element, or also upstream of the homogenizer or even upstream of the impeller pump provides for improved milk froth results. In particular if such a static mixer is located downstream of the homogenizer milk froth at milk temperatures above room temperature as well as at room temperature and even below room temperature can be produced with high quality.

LIST OF REFERENCE SIGNS

| | |
|---|---|
| 1 | water |
| 2 | water inlet valve |
| 3 | clean return valve |
| 4 | manifold valve block (1 + n) |
| 5 | cooling unit, fridge |
| 6 | liquid (milk) container (1 + n) |
| 7 | conductivity sensor |
| 8 | impeller pump |
| 9 | homogeniser |
| 10 | extractor system |
| 11 | heating elements, thickfilm |
| | heating system |
| 12 | valve (3/2 or 2x 2/2) for water |
| | flash or dispensing |
| 13 | outlet head |
| 14 | cleaning container |
| 15 | drink cup |
| 16 | waste water drain |
| 17 | flow meter fresh water control |
| 18 | check valve air line |
| 19 | air pump |
| 20 | motor |
| 21 | engine shaft |
| 22 | coupling unit, pump/motor |
| | connection |
| 23 | sidewall of 22 |
| 24 | opening in 23 |
| 25 | upper homogeniser toothed |
| | wheel, second extractor |
| 26 | lower homogeniser toothed |
| | wheel, main extractor |
| 27 | shaft of 26 directed to motor |
| 28 | coupling sleeve between 21 |
| | and 27 |
| 29 | bearing of 27 |
| 30 | shaft common to toothed |
| | wheel of impeller pump and |
| | 26 |
| 31 | housing of homogeniser |
| | toothed wheels |
| 32 | housing of impeller pump |
| | section |
| 33 | attachment flange of 22 to 31 |
| 34 | air inlet from air pump |
| 35 | milk inlet |
| 36 | foam outlet |
| 37 | impeller pump |
| 38 | toothed wheel of impeller |
| | pump |
| 39 | cavity for 38 |
| 40 | circular cylindrical section of |
| | 39 |
| 41 | flattened section of 39 with |
| | lower diameter than 40 |
| 42 | elastic vane, flexible tooth of |
| | 38 |
| 43 | widened tip proportion of 42 |
| 44 | rigid mounting portion of 38 |
| 45 | elastic portion of 38 |
| 46 | milk inlet into 39 |
| 47 | milk outlet out of 39 |
| 48 | premixing chamber for milk |
| | and air, entry channel to |
| | second extractor 25 |
| 49 | cavity for homogeniser |
| | toothed wheels/extractors |
| 50 | upper cavity portion for upper |
| | homogeniser toothed wheel |
| 51 | lower cavity portion for lower |
| | homogeniser toothed wheel |
| 52 | tooth of 25 |
| 53 | tooth of 26 |
| 54 | restricted portion of 49 |
| 55 | main extractor axis |
| 56 | upper extractor axis |
| 57 | the inlet/outlet to 48 |
| 58 | optional inlet/outlet connector |
| 59 | sealing ring |
| 60 | check valve |
| 61 | sealing ring |
| 62 | connecting protrusion for 34 |
| 63 | sealing ring |
| 64 | transition portion between 40 |
| | and 41 |
| 65 | transition portion between 40 |
| | and 41 opposite to 64 |
| 66 | static mixer |
| 67 | insert of 66 |
| 68 | outer tube of 66 |
| 69 | longitudinal sidewall |
| 70 | transverse wall section |
| 71 | flow through path |
| 72 | longitudinal wall section |
| 73 | converging wall section |
| 74 | flow direction |
| 75 | wall section |

1. Device for the production of milk froth, wherein the device comprises at least one pump for the suction of milk from at least one milk container (6), and downstream thereof a homogeniser (25, 26, 31),
wherein the pump is an impeller pump (8, 37) with an impeller toothed wheel (38) at least three elastic vanes (42),
wherein downstream of the impeller pump (8, 37) and upstream of the homogeniser (25, 26, 31) there is a mixing element (48) for introducing at least one of air and steam,
wherein the homogeniser (25, 26, 31) comprises at least two counter rotating toothed wheels (25, 26) mounted such that the teeth (52, 53) thereof are intertwining,
and wherein one of said toothed wheels (25, 26) and the impeller toothed wheel (38) of the impeller pump (37) are driven by the same motor (20).

2. Device according to claim 1, wherein the impeller toothed wheel (38) and one of said toothed wheels (26) are mounted on the same shaft or collinear coupled shafts (27, 30), preferably mounted collinear with an engine shaft (21) of said motor (20).

3. Device according to any of the preceding claims, wherein the impeller toothed wheel (38) comprises 4-10 elastic vanes (42), preferably 5-8 elastic vanes (42), wherein preferably each of the elastic vanes (42) has widened tip portion (43) to contact the walls (40, 41) of a cavity (39) of the impeller toothed wheel (38).

4. Device according to any of the preceding claims, wherein the impeller pump (8, 37) comprises a cavity (39) in which the impeller toothed wheel (38) is mounted, and wherein the inner wall of the cavity (39) comprises a circular cylindrical section (40) and opposite thereof a flattened section (41), wherein at the position with the smallest radius the radius in that flattened section (41) is at least 20%, preferably at least 30%, or at least 40% or 50% smaller than the radius of the circular cylindrical section (40)
and/or wherein the impeller pump (8, 37) and the homogeniser (25, 26, 31) are located in one common housing, preferably having an impeller pump section (32) and homogeniser section (31) attached to each other.

5. Device according to any of the preceding claims, wherein the impeller toothed wheel (38) is mounted on a shaft (30) which at the same time acts as at least partial shaft of one of said toothed wheels (26) and wherein this shaft (30) or in case of this shaft being a partial shaft of one of said toothed wheels (26) a further shaft (27) of said toothed wheel (26) is directly and collinearly connected with the engine shaft (21) of the motor.

6. Device according to any of the preceding claims, wherein the homogeniser comprises only two counter rotating toothed wheels (25, 26), and wherein said two counter rotating toothed wheels (25, 26) of the homogeniser are mounted in a housing (31), and wherein the housing (31) forms a cavity (49) with a first cavity portion (50) with essentially cylindrical shape and a second adjacent cavity portion (51) with essentially cylindrical shape, and wherein said portions (50, 51) are connected in a restricted portion (54), in which restricted portion the teeth (52, 53) of the counter rotating toothed wheels (25, 26) are intertwining.

7. Device according to any of the preceding claims, wherein the impeller pump (8, 37) comprises a cavity (39) in which the impeller toothed wheel (38) is mounted, and wherein the inner wall of the cavity (39) comprises a circular cylindrical section (40) and opposite thereof a flattened section (41), and wherein the milk inlet (35, 46) is located in a first transition portion (64) between the circular cylindrical section (40) and the flattened section (41) and wherein the milk outlet (47) is located in a second opposite transition portion between the circular cylindrical section (40) and the flattened section (41).

8. Device according to claim 7, wherein the mixing element (48) is located at the end of the milk outlet (47), wherein preferably the mixing element takes the form of a circular cylindrical mixing cavity, wherein preferably the mixing element (48) comprises an air inlet (34), the direction of introduction is essentially orthogonal to the direction of introduction of milk through the milk outlet (48), wherein preferably this air introduction direction is parallel to the axis of the circular cylindrical mixing cavity of the mixing element (48), and wherein further preferably the mixture exits the mixing element (48) to enter a cavity (50) of a toothed wheel (25) of the homogeniser which is not directly driven by the motor (20), wherein preferably the mixture exits the mixing element (48) in a direction essentially parallel to the air introduction direction.

9. Device according to any of the preceding claims, wherein it further comprises heating means (11) for heating the milk, wherein preferably the heating means (11) are provided downstream of the homogeniser (9) and/or are part of or integrated with the homogeniser (9).

10. Device according to any of the preceding claims, wherein the impeller toothed wheel (38) comprises a rigid mounting portion (44) mounted on a shaft (30), and wherein it comprises a circumferential elastic portion (45) integrally forming also the elastic vanes (42) and, if present, widened tip portions (43) thereof.

11. Device according to any of the preceding claims, wherein only one first toothed wheel (26) is driven by the motor (20), while the other second toothed wheel (25) is driven by said first toothed wheel (26) due to the intertwining of the respective teeth (52, 53).

12. Method for operating a device according to any of the preceding claims, wherein the impeller pump (8) sucks milk, preferably cold milk, from at least one milk container (6) and propels the milk into the mixing element (48), and wherein an air pump (19) sucks air and/or steam and propels it in parallel into the mixing element (48), wherein the mixture is fed into the homogeniser, preferably in a cavity portion (50) of a first homogeniser toothed wheel (25), and wherein milk froth exits the homogeniser from a cavity portion (51) of a second homogeniser toothed wheel (26) which is driven by the same motor (20) as the toothed wheel (38) of the impeller pump.

13. The method according to claim 12, wherein at the outlet (36) from the homogeniser (9) there is no flow cross-section constriction and/or valve to generate counter pressure, and wherein preferably in the homogeniser there is a pressure of at most 2 bar and/or a flow in the range of 5-20 ml/s, preferably in the range of 7-15 ml/s.

14. The method according to claim 12, wherein after production of milk froth or before production of milk froth the device is provided, instead of milk, with a cleaning liquid, if need be mixed with water, and operated with that cleaning liquid for a time span of at least 10 seconds, preferably at least 20 seconds, and subsequently the device is operated under condition where it is provided with clean water until the device is free from cleaning liquid.

15. Hot beverage preparation machine, in particular coffee machine, comprising a device according to any of the preceding claims 1-11 or being attached or coupled with a device according to any of the preceding claims 1-11, and/or being suitable and adapted to carry out the method according to any of the preceding claims 12-14.
